(19) United States
(12) Patent Application Publication
(10) Pub. No.: US 2022/0248912 A1
(43) Pub. Date: Aug. 11, 2022

(54) COOKING HARDWARE COMPATIBLE WITH A ROBOT END EFFECTOR

(71) Applicant: Nala Robotics, Inc., Arlington Heights, IL (US)

(72) Inventors: Vijay Kodali, Palatine, IL (US); Ajay Kumar Sunkara, South Barrington, IL (US)

(21) Appl. No.: 17/591,945

(22) Filed: Feb. 3, 2022

Related U.S. Application Data
(60) Provisional application No. 63/148,249, filed on Feb. 11, 2021.

(51) Int. Cl. A47J 44/00; A47J 36/32

(52) U.S. Cl. CPC A47J 44/00; B25J 11/0045; A47J 36/32

(57) ABSTRACT

A cooking hardware is configured for selectively engaging an end effector of a robot arm, the cooking hardware including a handle, a body, an aperture, and a first handle protrusion. The handle has a proximal end portion and a distal end portion. The body is fixed with the distal end portion of the handle, the body being configured for containing food items. The aperture is defined in the handle and extended in a longitudinal direction of the handle from the proximal end of the handle toward the distal end of the handle, where the aperture is configured to receive the end effector such that the robot arm is capable of maneuvering the cooking hardware about a kitchen station through the handle with the end effector. The first handle protrusion is extended outward from the handle in a width direction of the handle perpendicular to the longitudinal direction.

### BACKGROUND

Automated cooking systems can be advantageous over conventional human-driven cooking for reducing an amount of human effort expended in preparing a meal, and for improving aspects of reliability, consistency, quality, and safety in prepared meals beyond reasonable human abilities. Robot arms employed in automated cooking systems with industry standard grippers, however, often face difficulty in establishing a functional grip on, and manipulating cooking hardware and utensils originally designed for human use.

### BRIEF DESCRIPTION

According to one aspect, a cooking hardware is configured for selectively engaging an end effector of a robot arm, the cooking hardware including a handle, a body, an aperture, and a first handle protrusion. The handle has a proximal end portion and a distal end portion. The body is fixed with the distal end portion of the handle, the body being configured for containing food items. The aperture is defined in the handle and extended in a longitudinal direction of the handle from the proximal end of the handle toward the distal end of the handle, where the aperture is configured to receive the end effector such that the robot arm is capable of maneuvering the cooking hardware about a kitchen station through the handle with the end effector. The first handle protrusion is extended outward from the handle in a width direction of the handle perpendicular to the longitudinal direction.

A cooking hardware support system, a cooking hardware and a mount. The cooking hardware is configured for selectively engaging an end effector of a robot arm and includes a handle, a body, an aperture, and a first handle protrusion. The handle has a proximal end portion and a distal end portion. The body is fixed with the distal end portion of the handle, the body being configured for containing food items. The aperture defined in the handle and extended in a longitudinal direction of the handle from the proximal end of the handle toward the distal end of the handle, where the aperture is configured to receive the end effector. The first handle protrusion is extended outward from the handle in a width direction of the handle perpendicular to the longitudinal direction. The mount is configured for supporting the handle on a kitchen station. The mount includes a stand, a first arm, and a first arm protrusion. The stand is configured for being mounted on the kitchen station. The first arm is extended from the stand in a height direction of the handle perpendicular to the longitudinal direction and the width direction of the handle. The first arm protrusion is extended from the first arm in the width direction of the handle, and disposed along the first arm in the height direction of the handle. When the handle is lowered onto the mount, the handle and the first handle protrusion slide against the first arm and the first arm protrusion in the height direction of the handle from a free position toward a supported position where the stand, the first arm, and the first arm protrusion support the handle in a height direction of the kitchen station, obstruct movement of the handle in the longitudinal direction and the width direction of the handle, and maintain the handle in an upright orientation such that the height direction of the handle is aligned with the height direction of the kitchen station.

### BRIEF DESCRIPTION OF THE DRAWINGS

FIG. 1 depicts a perspective view of a kitchen station including a first pan, a first mount, a first stove, a second pan, a second mount, and a second stove, according to one aspect.

FIG. 2 depicts a perspective view of the kitchen station including the first pan, the first mount, and the first stove, according to one aspect.

FIG. 3 depicts a perspective exploded view of the first pan and the first mount, according to one aspect.

FIG. 4 depicts a robot arm at the kitchen station, according to one aspect.

FIG. 5 depicts a partial perspective view of the robot arm including the first pan, according to one aspect.

FIG. 6 depicts a partial perspective view of the robot arm including the first pan, according to one aspect.

FIG. 7 depicts a side view of the robot arm at the kitchen station, according to one aspect.

FIG. 8 depicts an enlarged, partial side view of the robot arm at the kitchen station, according to one aspect.

FIG. 9 depicts a top view of the robot arm at the kitchen station, engaged with the first pan, according to one aspect.

FIG. 10 depicts an enlarged, partial top view of the robot arm at the kitchen station, according to one aspect.

### DETAILED DESCRIPTION

Here, end effectuators that are compatible with cooking hardware and utensils and robot arms are provided for automated cooking systems. Because the end effectuators are designed to enable the robot arms to perform automated cooking tasks with the cooking hardware and the utensils, the robot arms are able establish a functional grip and manipulate the cooking hardware and the utensils.

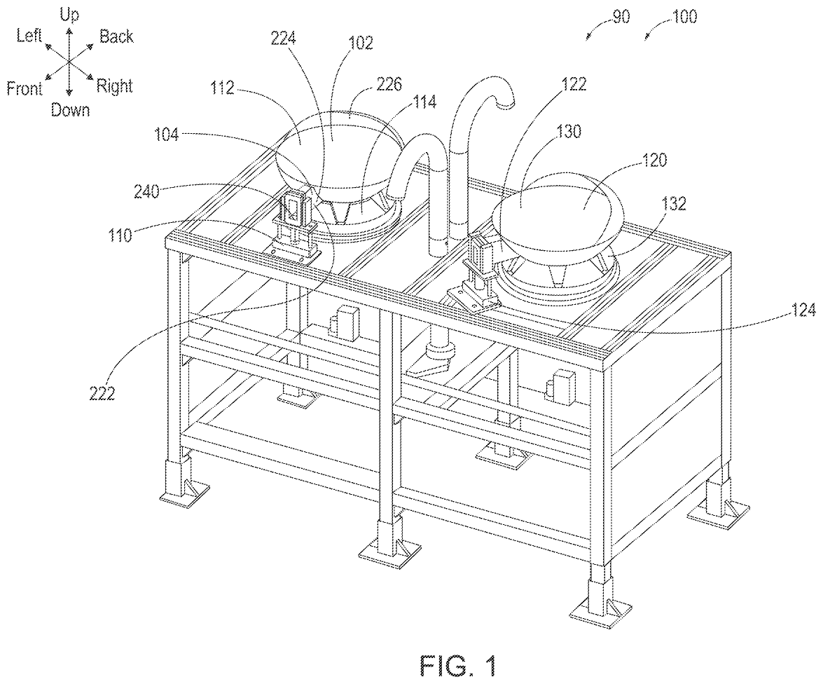

The description and drawings herein are merely illustrative and that various modifications and changes can be made in the structures disclosed without departing from the present disclosure. Referring now to the drawings, wherein like numerals refer to like parts throughout the several views, FIG. 1 depicts a cooking hardware support system 90 that includes a kitchen station 100, and a first pan 102 with a first handle 104 supported on the kitchen station 100 by a first mount 110 and a first body 112 supported on a first stove 114 disposed in the kitchen station 100. The cooking hardware support system 90 also includes a second pan 120 with a second handle 122 supported on the kitchen station 100 by a second mount 124 and a second body 130 supported on a second stove 132 disposed in the kitchen station 100. The first pan 102 and the second pan 120 are each a type of cooking hardware respectively configured for containing food items (not shown) in the first body 112 and the second body 130 over the first stove 114 and the second stove 132, and being supported from the first handle 104 and the second handle 122 for containing the food items over the first stove 114 and the second stove 132.

The first mount 110 is fixed to the kitchen station 100 about the first stove 114, and the first handle 104 is retained in the first mount 110 such that the first body 112 is supported over the first stove 114. As depicted, the first body 112 rests on the first stove 114 when the first handle 104 is received in the first mount 110 such that the first stove 114 supports the first body 112 over the first stove 114, and in this manner the first stove 114 cooperatively supports the first pan 102 with the first mount 110. While the depicted first pan 102 is cooperatively supported on the first mount 110 and the first stove 114, the first mount 110 may be alternatively configured to independently support the first pan 102 over the first stove 114, without additional support to the first pan 102 from the first stove 114, without departing from the scope of the present disclosure.

The second mount 124 is fixed to the kitchen station 100 about the second stove 132, and the second handle 122 is retained in the second mount 124 such that the second body 130 is supported over the second stove 132. As depicted, the second body 130 rests on the second stove 132 when the second handle 122 is received in the second mount 124 such that the second stove 132 supports the second body 130 over the second stove 132, and in this manner the second stove 132 cooperatively supports the second pan 120 with the second mount 124. While the depicted second pan 120 is cooperatively supported on the second mount 124 and the second stove 132, the second mount 124 may be alternatively configured to independently support the second pan 120 over the second stove 132, without additional support to the second pan 120 from the second stove 132, without departing from the scope of the present disclosure.

The second pan 120, the second mount 124, and the second stove 132 respectively feature a construction similar to the first pan 102, the first mount 110, and the first stove 114. Unless otherwise stated, the following description made with reference to the first pan 102, the first mount 110, and the first stove 114 is similarly applicable to the second pan 120, the second mount 124, and the second stove 132.

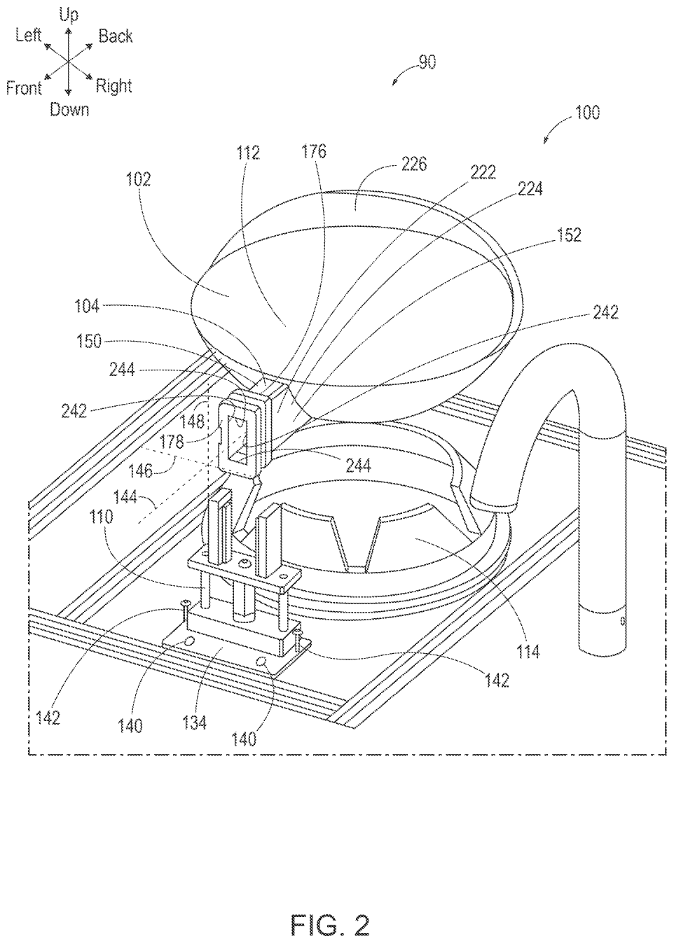

FIG. 2 depicts an enlarged partial view of the kitchen station 100 as shown in FIG. 1, including the first pan 102, the first mount 110, and the first stove 114. As depicted in FIG. 2, the first mount 110 includes a base plate 134 configured for being mounted on the kitchen station 100, fixing the first mount 110 to the kitchen station 100 relative to the first stove 114. To this end, the first mount 110 is removably fixed to the kitchen station 100 through holes 140 defined in the base plate 134, where fasteners 142 such as screws are driven through the holes 140 and toward the kitchen station 100. While the depicted fasteners 142 are screws, alternative fasteners types configured for removably fixing the first mount 110 to the kitchen station 100, such as nuts and bolts, may be employed in addition or alternative to the fasteners 142 without departing from the scope of the present application. In an alternative embodiment, the first mount 110 is permanently fixed to the kitchen station 100 about the first stove 114.

With the first mount 110 removably fixed to the kitchen station 100 about the first stove 114, the first mount 110 is configured for being repositioned on the kitchen station 100 about the first stove 114, and fastened to the kitchen station 100 to retain the first handle 104 and support the first body 112 over the first stove 114. Because the first mount 110 is configured for receiving the first handle 104, the first handle 104 may be repositioned about the first stove 114 with the first mount 110. The first mount 110 is configured for receiving the first handle 104 from a free position where the first handle 104 is not obstructed from movement by the first mount 110, to a supported position where the first mount 110 supports the first handle 104 in an up-down direction that is a height direction of the kitchen station 100.

As shown, a front-back direction of the cooking hardware support system 90 is a first lateral direction of the kitchen station 100. A left-right direction of the cooking hardware support system 90 is a second lateral direction of the kitchen station 100. An up-down direction of the cooking hardware support system 90 is a height direction of the kitchen station 100. When the first handle 104 is in the supported position on the first mount 110, the first mount 110 maintains the first handle 104 in an upright orientation. In the upright orientation, a longitudinal direction 144 of the first handle 104 is aligned with the first lateral direction of the kitchen station 100. In the upright orientation, a width direction 146 of the first handle 104 perpendicular to the longitudinal direction 144 is aligned with the second lateral direction of the kitchen station 100. In the upright orientation, a height direction 148 of the first handle 104 orthogonal to the longitudinal direction 144 and the width direction 146 is aligned with the height direction of the kitchen station 100. In the upright orientation, a top portion 150 of the first handle 104 located above a bottom portion 152 of the first handle 104, and the first body 112 oriented for containing food items over the first stove 114. When the first handle 104 is in the supported position on the first mount 110, the first mount 110 obstructs movement of the first handle 104 in the longitudinal direction 144 and the width direction 146 of the first handle 104.

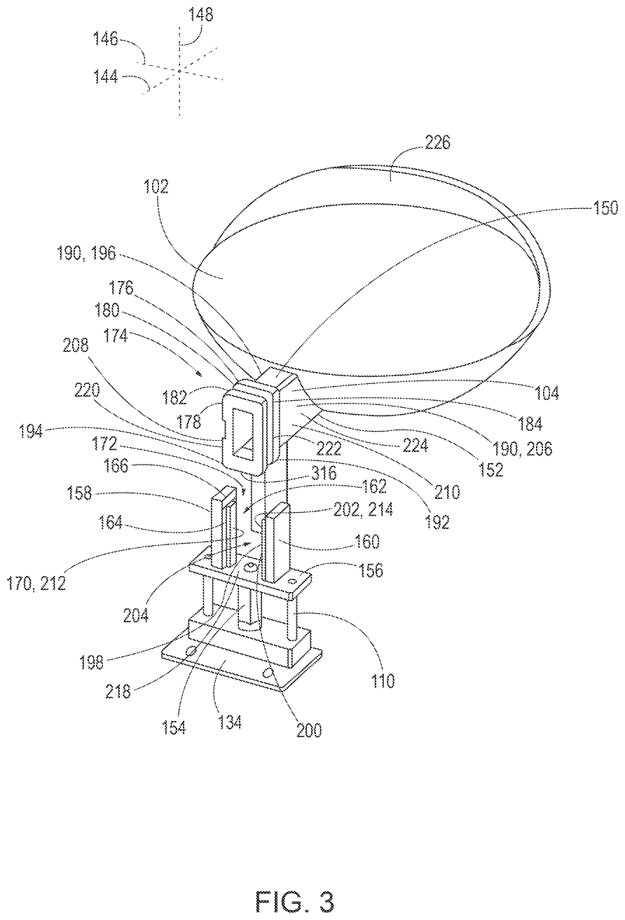

FIG. 3 depicts a perspective exploded view of the first pan 102 and the first mount 110. The first mount 110 includes a stand 154 supported on and fixed with the base plate 134. The stand 154 includes a top plate 156, and a first arm 158 and a second arm 160 that extend from the top plate 156 in the height direction 148 of the first handle 104. As depicted, the first arm 158 and the second arm 160 are positioned separated from each other along the top plate 156 to form an arm gap 162 between the first arm 158 and the second arm 160 in the width direction 146 of the first handle 104. The arm gap 162 defined between the first arm 158 and the second arm 160 has a width corresponding to a width of the first handle 104 for receiving the first handle 104 in the supported position between the first arm 158 and the second arm 160. In this manner, the stand 154, the first arm 158, and the second arm 160 are configured for being mounted on the kitchen station 100 to receive the first handle 104 such that the first handle 104 rests on the top plate 156 and is retained on the top plate 156 in the supported position between the first arm 158 and the second arm 160 along the top plate 156.

The first arm 158 and the second arm 160 extend from the top plate 156 in parallel with each other, and upward from the top plate 156 when the first mount 110 is positioned on the kitchen station 100. In this manner, the first mount 110 is configured for receiving the first handle 104 in the upright orientation by having the first handle 104 lowered onto the top plate 156 between the first arm 158 and the second arm 160.

A first arm protrusion 164 extends from an inner surface 166 of the first arm 158 into the arm gap 162 and towards the second arm 160 in the width direction 146 of the first handle 104. The first arm protrusion 164 forms a first arm elevated surface 170 spaced from the inner surface 166 of the first arm 158 in the width direction 146 of the first handle 104. The first arm protrusion 164 and the inner surface 166 of the first arm 158 form a surface pattern 172 in the first arm 158 that corresponds with a surface pattern 174 of the first handle 104 for engaging the first handle 104 in the supported position.

As shown, the surface pattern 174 in the first arm 158 is formed from a first handle protrusion 176 and a second handle protrusion 178 extended outward from the first handle 104 in the width direction 146 of the first handle 104 and the height direction 148 of the first handle 104, and separated from each other in the longitudinal direction 144 of the first handle 104. The first handle protrusion 176 defines a first handle elevated surface 180 along a side of the first handle protrusion 176 opposite the first handle 104 in the width direction 146 of the first handle 104, and the second handle protrusion 178 defines a second handle elevated surface 182 along a side of the second handle protrusion 178 opposite the first handle 104 in the width direction 146 of the first handle 104. The first handle protrusion 176 and the second handle protrusion 178 define a handle gap 184 therebetween in the longitudinal direction 144 of the first handle 104, the handle gap 184 extending from the first handle 104 to the first handle elevated surface 180 and second handle elevated surface 182 in the width direction 146 of the first handle 104.

With continued reference to FIG. 3, the first handle protrusion 176 and the second handle protrusion 178 each form a rib disposed on the first handle 104, along a perimeter of the first handle 104, in the width direction 146 and the height direction 148 of the first handle 104. The first handle protrusion 176 and the second handle protrusion 178 each extend outward from opposite lateral sides 190 of the first handle 104 in the width direction 146 of the first handle 104, and extend outward from the top portion 150 and the bottom portion 152 of the first handle 104 in the height direction 148 of the first handle 104. With this construction, the handle gap 184 defined between the first handle protrusion 176 and the second handle protrusion 178 extends along the perimeter of the first handle 104, including along the opposite lateral sides 190, the top portion 150, and the bottom portion 152. The handle gap 184 also extends outward from the first handle 104, from the opposite lateral sides 190 in the width direction 146 of the first handle 104, and from the top portion 150 and the bottom portion 152 in the height direction 148 of the first handle 104, where the handle gap 184 extends from the first handle 104 to the first handle elevated surface 180 and the second handle elevated surface 182.

The first handle protrusion 176 and the second handle protrusion 178 are disposed along the opposite lateral sides 190 of the first handle 104, from the bottom portion 152 toward the top portion 150 of the first handle 104 in the height direction 148 of the first handle 104. The first arm protrusion 164 is disposed along the inner surface 166 of the first arm 158 in the height direction 148 of the first handle 104 such that when the first handle 104 is lowered to the supported position on the first mount 110, the first handle 104, the first handle protrusion 176, and the second handle protrusion 178 slide against the first arm 158 and the first arm protrusion 164 in the height direction 148 of the first handle 104 from the free position toward the supported position. The stand 154 engages the bottom portion 152 of the first handle 104, and the first arm protrusion 164 engages the first handle 104 between the first handle protrusion 176 and the second handle protrusion 178 when the first handle 104 is in the supported position on the first mount 110. With the first handle 104 in the supported position, the first arm protrusion 164 interlocks with the first handle protrusion 176 and the second handle protrusion 178 in the longitudinal direction 144 of the first handle 104, obstructing movement of the first handle 104 in the longitudinal direction 144 of the first handle 104. Also with the first handle 104 in the supported position, the first arm 158 and the first arm protrusion 164 obstruct movement of the first handle 104 in the width direction 146 of the first handle 104.

With continued reference to FIG. 3, the first handle protrusion 176 and the second handle protrusion 178 are each disposed continuously from the bottom portion 152 to the opposite lateral sides 190 of the first handle 104 to form first corners 192 in the first handle protrusion 176 and form second corners 194 in the second handle protrusion 178 between the bottom portion 152 and the opposite lateral sides 190 of the first handle 104. With this, the first arm protrusion 164 is disposed along a first lateral side 196 of the first handle 104, from the bottom portion 152 toward the top portion 150 of the first handle 104 such that the bottom portion 152 of the first handle 104 and the first arm protrusion 164 are received against the stand 154, and the first arm protrusion 164 is received against the first handle 104, the first handle protrusion 176, and the second handle protrusion 178 when the first handle 104 is in the supported position.

The first corners 192 and the second corners 194 are each rounded to form an inclined surface extended toward the first handle 104 in the width direction 146 and away from the first handle 104 in the height direction 148 of the first handle 104 such that when the first handle 104 is lowered onto the first mount 110 in the height direction 148 of the first handle 104, contact between the first corners 192 and the first arm 158 or the second arm 160, and contact between the second corners 194 and the first arm 158 or the second arm 160 presses the first handle 104 toward the arm gap 162 in the width direction 146 of the first handle 104. While, as depicted, the first corners 192 and the second corners 194 are rounded, the first corners 192 and the second corners 194 may additionally or alternatively be chamfered or otherwise angled toward the first handle 104 in the width direction 146 and away from the first handle 104 in the height direction 148 of the first handle 104 for guiding the first handle 104 in the arm gap 162 when the first handle 104 is lowered to the supported position without departing from the scope of the present disclosure.

With continued reference to FIG. 3, when the first handle 104 is received by the first mount 110, the first arm protrusion 164 is received in the handle gap 184 such that the first arm elevated surface 170 is spaced from the first arm 158 toward the first handle 104, beyond the first handle elevated surface 180 and the second handle elevated surface 182. As such, the surface pattern 172 of the first arm 158 and the surface pattern 174 of the first handle 104 are interlocked through the first arm protrusion 164, the first handle protrusion 176, and the second handle protrusion 178. In this manner, the surface pattern 172 of the first arm 158 and the surface pattern 174 of the first handle 104 engage each other in a tongue and groove assembly to obstruct movement of the first pan 102 in the longitudinal direction of the first handle 104 relative to the first mount 110 so as to retain the first handle 104 in the supported position on the top plate 156 of the first mount 110.

The second arm 160 includes similar features, and functions in a similar manner as the first arm 158. To this end, a second arm protrusion 198 extends from an inner surface 200 of the second arm 160 into the arm gap 162 and towards the first arm 158 in the width direction 146 of the first handle 104. The second arm protrusion 198 forms a second arm elevated surface 202 spaced from the inner surface 200 of the second arm 160 in the width direction 146 of the first handle 104. The second arm protrusion 198 is disposed along the second arm 160 in the height direction 148 of the first handle 104 such that the first handle 104, the first handle protrusion 176, and the second handle protrusion 178 are configured to slide against the second arm 160 and the second arm protrusion 198 in the height direction 148 of the first handle 104 between the free position and the supported position, and configured to engage the first mount 110 in the supported position so as to obstruct movement of the first handle 104 in the longitudinal direction 144 and the width direction 146 of the first handle 104, and maintain the first handle 104 in the upright orientation.

The second arm protrusion 198 and the inner surface 200 of the second arm 160 form a surface pattern 204 in the second arm 160 that corresponds with the surface pattern 174 of the first handle 104. With this construction, when the first handle 104 is received by the first mount 110 in the supported position, the second arm protrusion 198 is received in the handle gap 184 with the first arm protrusion 164, where the second arm elevated surface 202 is spaced from the second arm 160 beyond the first handle elevated surface 180 and the second handle elevated surface 182. As such, the surface pattern 174 of the first handle 104 and the surface pattern 172 of the first arm 158 are interlocked, and the surface pattern 174 of the first handle 104 and the surface pattern 204 of the second arm 160 are interlocked through the first arm protrusion 164, the second arm protrusion 198, the first handle protrusion 176, and the second handle protrusion 178. With this construction, when the first handle 104 is in the supported position, the first arm protrusion 164 and the second arm protrusion 198 are each interlocked between the first handle protrusion 176 and the second handle protrusion 178 in the longitudinal direction 144 of the first handle 104, and engaged with the opposite lateral sides 190 at the surface pattern 174 of the first handle 104 along the height direction 148 of the first handle 104.

With continued reference to FIG. 3, the first handle protrusion 176 and the second handle protrusion 178 extend downward from the bottom portion 152 of the first handle 104 in the height direction 148 of the first handle 104 to directly engage the stand 154 in the supported position, and extend outward in the width direction 146 of the first handle 104 from the opposite lateral sides 190 of the first handle 104 to directly engage the first arm 158 and the second arm 160 in the supported position. In this manner, the surface pattern 204 of the second arm 160 and the surface pattern 174 of the first handle 104 engage each other in a tongue and groove assembly to obstruct movement of the first pan 102 in the longitudinal direction of the first handle 104 relative to the first mount 110 so as to retain the first handle 104 in the first mount 110, on the top plate 156.

When the first handle 104 is received in the first mount 110, the first arm 158 obstructs the first handle 104 from moving in a first direction along the width direction 146 of the first handle 104, the second arm 160 obstructs movement of the first handle 104 in an opposing second direction along the width direction 146 of the first handle 104, and the top plate 156 obstructs movement of the first handle 104 downward in the height direction 148 of the first handle 104. The first arm 158, the first arm protrusion 164, the second arm 160, and the second arm protrusion 198 extend straight upward from the stand 154 in the height direction 148 of the first handle 104 such that movement of the first handle 104 between the free position and the supported position is restricted to linear movement in the height direction 148 of the first handle 104 with the first handle 104 in the upright orientation. With the first arm 158 and the second arm 160 extended in parallel with each other and upward in the height direction 148 of the first handle 104, the first handle 104 is not obstructed from vertical movement relative to the first mount 110 until the first handle 104 is lowered onto and abuts the top plate 156. In this manner, the first handle 104 is configured for being lowered into and raised out of the first mount 110, where a weight of the first pan 102 including the first handle 104 retains the first handle 104 on the top plate 156, between the first arm 158 and the second arm 160.

With continued reference to FIG. 3, the first handle 104 features a rectangular profile that is complementary with the first arm 158 and the second arm 160 where, when the first handle 104 is received in the first mount 110, the first handle 104 fits in the arm gap 162 between the first arm 158 and the second arm 160, and engages the first arm 158 and the second arm 160 such that the first handle 104 is obstructed from rotating about the longitudinal direction 144 of the first handle 104. To this end, the opposite lateral sides 190 of the first handle 104 include the first lateral side 196 and a second lateral side 206, where the first lateral side 196 of the first handle 104 defines a planar first lateral side surface 208 and the second lateral side 206 of the first handle 104 defines a planar second lateral side surface 210. The first arm 158 defines a planar first arm surface 212 configured to directly engage the first lateral side surface 208 in the supported position, and the second arm 160 defines a planar second arm surface 214 configured to directly engage the second lateral side surface 210 in the supported position. The bottom portion 152 of the first handle 104 defines a planar bottom side surface 216, and the stand 154 defines a planar stand support surface 218 configured to directly engage the bottom side surface 216 in the supported position. The surface pattern 174 of the first handle 104 is complementary with the surface pattern 172 of the first arm 158 and the surface pattern 204 of the second arm 160 such that the first handle 104 is obstructed from rotating from the upright orientation, and is obstructed from moving in the longitudinal direction 144 and the width direction 146 of the first handle 104 when the first handle 104 is received in the first mount 110 in the supported position.

The surface pattern 174 of the first handle 104 is formed from a sleeve 220 fitted onto a proximal end portion 222 of the first handle 104. While the depicted surface pattern 174 is formed from the sleeve 220 fitted onto the first handle 104, the surface pattern 174 may be otherwise formed from an attachment fixed with the first handle 104 or integrally formed from the first handle 104 without departing from the scope of the present disclosure.

When the first handle 104 is received in the first mount 110, the surface pattern 174 of the first handle 104 forms a tongue and groove assembly with the surface pattern 172 of the first arm 158, and forms a tongue and groove assembly with the surface pattern 204 of the second arm 160. The relative positions of the surface pattern 174 on the first handle 104 may be switched with the surface pattern 172 of the first arm 158 and the surface pattern 204 of the second arm 160, reversing the pattern of the tongue and groove assembly therebetween when the first handle 104 is received in the first mount 110, without departing from the scope of the present disclosure. Further, while the surface pattern 174 of the first handle 104, the surface pattern 172 of the first arm 158, and the surface pattern 204 of the second arm 160 as depicted in the present disclosure are configured to form tongue and groove assemblies when the first handle 104 is received in the first mount 110, the surface pattern 174 of the first handle 104, the surface pattern 172 of the first arm 158, and the surface pattern 204 of the second arm 160 may be otherwise shaped to slide and pass each other when the first handle 104 is lowered into or raised out of the first mount 110, and configured to interlock the first handle 104 and the first mount 110 such that the first handle 104 is retained in the first mount 110 without departing from the scope of the present disclosure.

The first pan 102 includes the first body 112 fixed with a distal end portion 224 of the first handle 104, the first body 112 being configured for containing food items (not shown) for cooking over the first stove 114 when the first pan 102 is in the upright position. The first body 112 includes a hood 226 which extends from an end of the first body 112 opposite from where the proximal end portion 222 of the first handle 104 is fixed with the first body 112. The hood 226 partially covers the first body 112 of the first pan 102 with respect to the vertical direction of the first pan 102 such that the first pan 102 and the hood 226 form a concave portion of the first pan 102 with respect to a direction taken from an interior of the first body 112 toward an exterior of the first body 112. The concave portion of the first pan 102 is configured for retaining the food items in the interior of the first body 112.

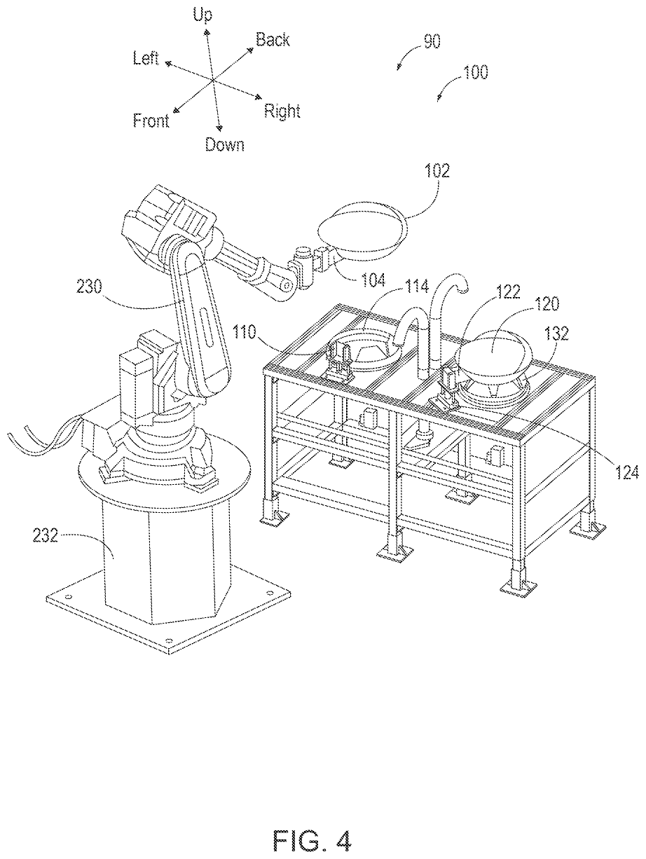

FIG. 4 depicts a robot arm 230 at the kitchen station 100 maneuvering the first pan 102 while the second pan 120 is received in the second mount 124. The robot arm 230 is supported by, and fixed on a base 232 at the kitchen station 100 within a reaching range of the robot arm 230 such that the robot arm 230 is capable of reaching the first handle 104 to raise the first handle 104 out of the first mount 110 and lower the first handle 104 into the first mount 110, and is capable of reaching the second handle 122 to raise the second handle 122 out of the second mount 124 and lower the second handle 122 into the second mount 124. Because the first pan 102 and the first mount 110 respectively have similar features and function in a similar manner as the second pan 120 and the second mount 124, the robot arm 230 may switch the positioning of the first pan 102 and the second pan 120 with respect to the first mount 110, the first stove 114, the second mount 124, and the second stove 132.

As depicted, the robot arm 230 is positioned directly in front of the first stove 114 with respect to a front-back direction of the kitchen station 100, and at an angle from the second stove 132 with respect to the front-back direction of the kitchen station 100 and a left-right direction of the kitchen station. The first mount 110 and the second mount 124 are respectively positioned at the first stove 114 and the second stove 132 with an angle directed toward the robot arm 230 to facilitate the robot arm 230 raising and lowering the first handle 104 and the second handle 122 respectively from the first mount 110 and the second mount 124.

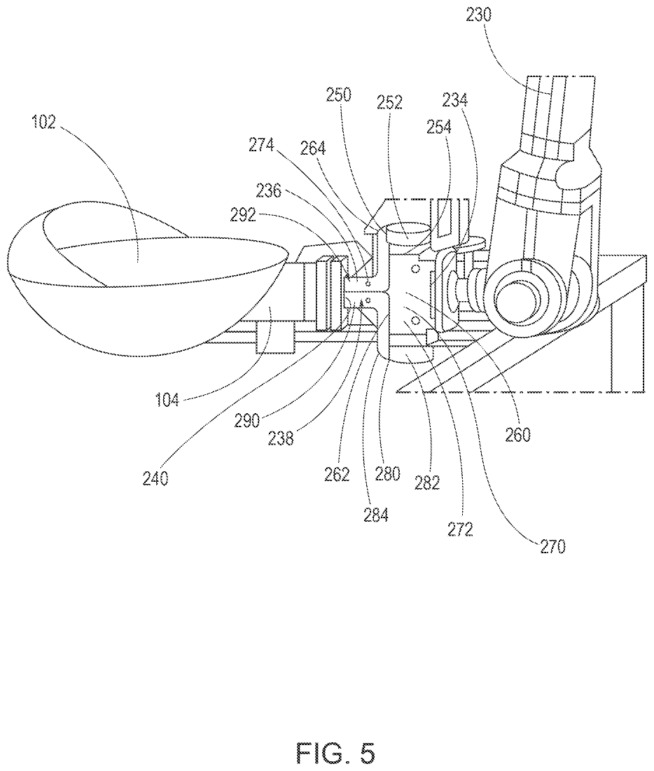

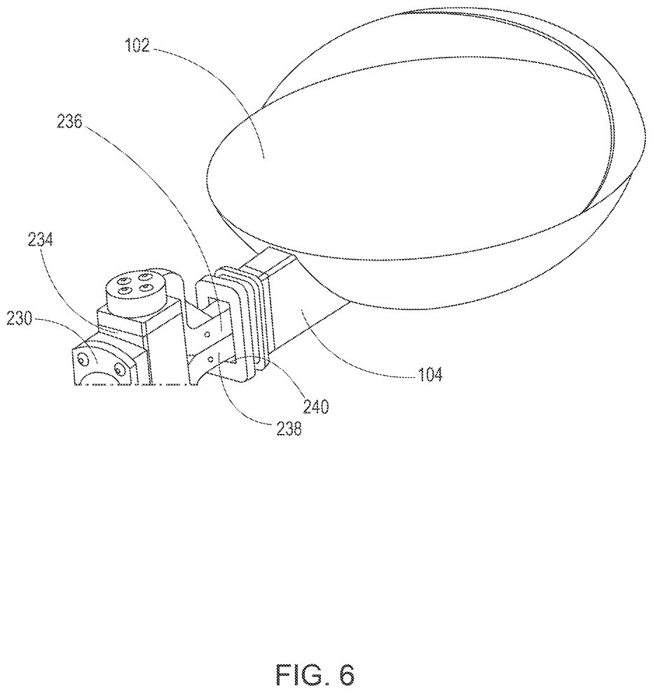

FIGS. 5 and 6 each depict a partial perspective view of the robot arm 230 including the first pan 102, where the robot arm 230 is engaged with the first pan 102 through an end effector 234 fixed to the robot arm 230. The end effector 234 includes a first finger 236 and a second finger 238 configured for gripping one of the first handle 104 and the second handle 122 such that the robot arm 230 is capable of raising and lowering the one of the first handle 104 and the second handle 122 out of and into the first mount 110 and the second mount 124.

The first handle 104 is configured for engaging the first finger 236 and the second finger 238 in an aperture 240 such that the first pan 102 is selectively fixed with the end effector 234 and by extension the robot arm 230. As such, the robot arm 230 is capable of selectively fixing the end effector 234 with the first handle 104 in the aperture 240 to maneuver the first pan 102 about the kitchen station 100 through the end effector 234.

As shown in FIG. 2, the first handle 104 defines a first aperture 240 configured to receive the first finger 236 and the second finger 238 of the end effector 234 such that the robot arm 230 is capable of selectively gripping and maneuvering the first pan 102 about the kitchen station 100 through the first handle 104 with the end effector 234. The aperture 240 is extended in the longitudinal direction 144 of the first handle 104 from the proximal end portion 222 toward the distal end portion 224 with a length, width, and height configured for receiving the first finger 236 and the second finger 238 in an ungripped position where at least one of the first finger 236 and the second finger 238 are actuated toward the other of the first finger 236 and the second finger 238, and configured for directly engaging interior surfaces of the first handle 104 defining the aperture 240 in a gripped position such that the first handle 104 is selectively fixed with the robot arm 230 through the end effector 234 at the first finger 236 and the second finger 238.

The aperture 240 is defined by vertical inner wall surfaces 242 of the first handle 104 that extend straight in the height direction 148 of the first handle 104 a distance corresponding with a thickness of the first finger 236 and the second finger 238, and an actuation distance of the first finger 236 and the second finger 238 between the ungripped position and the gripped position in the height direction 148 of the first handle 104 for receiving the first handle 104 in the ungripped position and engaging the first handle 104 in the gripped position. The aperture 240 is also defined by horizontal inner wall surfaces 244 of the first handle 104 that extend straight in the width direction 146 of the first handle 104 a distance corresponding to a thickness of the first finger 236 and the second finger 238 in the width direction 146 of the first handle 104 for receiving the first finger 236 and the second finger 238 in the aperture 240. The horizontal inner wall surfaces 244 define planar surface areas between the vertical inner wall surfaces 242 in the width direction 146 of the first handle 104 for engaging the first finger 236 and the second finger 238 and fixing the first handle 104 with the end effector 234.

The first handle protrusion 176 and the second handle protrusion 178 each occupy a same position as the aperture in the longitudinal direction 144 and the height direction 148 of the first handle 104. With this construction, the first handle 104 is configured for being gripped by the end effector 234 at a same position the first handle 104 is configured for being supported by the first mount 110.

The second pan 120 includes similar features and functions in a similar manner as the first pan 102, and the following description of the end effector 234 engaging with the first pan 102 is also applicable to the second pan 120. With reference to FIGS. 5 and 6, when the first finger 236 and the second finger 238 are inserted into the first handle 104, the end effector 234 is configured to actuate at least one of the first finger 236 and the second finger 238 to lock the end effector 234 with the first handle 104. In an embodiment, when the first finger 236 and the second finger 238 are inserted into the first handle 104, the end effector 234 actuates the at least one of the first finger 236 and the second finger 238 by moving the at least one of the first finger 236 and the second finger 238 in a direction away from the other of the first finger 236 and the second finger 238 until the first finger 236 and the second finger 238 abut the first handle 104 in the first aperture 240, locking the end effector 234 with the first pan 102. Also in an embodiment, the end effector 234 is configured to retract at least one of the first finger 236 and the second finger 238 toward the other of the first finger 236 and the second finger 238 to disengage the first finger 236 and the second finger 238 from the first handle 104 in the first aperture 240 to unlock the end effector 234 from the first pan 102, and to move the first finger 236 and the second finger 238 in the first handle 104 along the longitudinal direction of the first handle 104 without obstruction between the first finger 236, the second finger 238, and the first handle 104.

While the depicted first finger 236 and second finger 238 are configured for being actuated in the first handle 104 and the second handle 122 for respectively locking the end effector 234 with the first pan 102 and the second pan 120, the first finger 236 and the second finger 238 may additionally or alternatively feature permanent magnets, electric magnets, mechanically actuated assemblies which further interlock the end effector 234 with the first pan 102 and the second pan 120, or have complementary contours which passively lock the end effector 234 with the first pan 102 and the second pan 120 without departing from the scope of the present disclosure. Notably, because the first handle 104 is received in the first mount 110 when the first finger 236 and the second finger 238 are inserted into the first handle 104, and the first mount 110 is configured to obstruct movement of the first handle 104 in the longitudinal direction of the first handle 104, the end effector 234 does not move the first handle 104 in the longitudinal direction of the first handle 104 when the first finger 236 and the second finger 238 are being inserted into or out of the first handle 104.

As depicted in FIG. 5, the first finger 236 has a proximal end portion 250 fixed to a first plunger 252 supported on a first end portion 254 of a hand 260 included in the end effector 234, where the proximal end portion 250 extends from the first plunger 252 around the hand 260 from the first end portion 254 toward a front side 262 of the hand 260, forming a first shoulder 264 in the first finger 236. The first finger 236 extends from the first shoulder 264 toward a middle portion 270 of the hand 260 that is interposed between and separates the first end portion 254 and a second end portion 272 of the hand 260, the second end portion 272 being disposed on a side of the hand 260 opposite from the first end portion 254. A distal end portion 274 of the first finger 236 extends away from the front side 262 of the hand 260 at the middle portion 270, and is configured for insertion into the first aperture 240 of the first handle 104.

The second finger 238 has similar features and functions in a similar manner as the first finger 236. To this end, the second finger 238 has a proximal end portion 280 fixed to a second plunger 282 supported on the second end portion 272 of the hand 260, where the proximal end portion 280 extends from the second plunger 282 around the hand 260 from the second end portion 272 toward the front side 262 of the hand 260, forming a second shoulder 284 in the second finger 238. The second finger 238 extends from the second shoulder 284 toward the middle portion 270 of the hand 260, and a distal end portion 290 of the second finger 238 extends away from the front side 262 of the hand 260 at the middle portion 270, and is configured for insertion into the first aperture 240 of the first handle 104.

The distal end portion 274 of the first finger 236 and the distal end portion 290 of the second finger 238 form a neck 292 at the middle portion 270 between the first shoulder 264 and the second shoulder 284 along the front side 262 of the hand 260. The neck 292 is configured for insertion into the first aperture 240 of the first handle 104. In an embodiment, the neck 292 is formed when the first finger 236 and the second finger 238 are retracted toward each other for insertion into the first aperture 240 of the first handle 104. The robot arm 230 is configured to maneuver the hand 260 around the kitchen station 100 and actuate the hand 260, including actuating the first finger 236 and the second finger 238 to selectively move toward each other and move away from each other along the front side 262 of the hand 260, and in this manner the robot arm 230 is configured to selectively insert the hand 260 into the first handle 104, lock the hand 260 with the first handle 104, and maneuver the first pan 102 through the first handle 104 with hand 260.

While the first finger 236 and the second finger 238 respectively include the first shoulder 264 and the second shoulder 284 and extend toward the middle portion 270 of the hand 260 to form the neck 292 with each other at the middle portion 270, the first finger 236 and the second finger 238 may alternatively extend toward the first end portion 254 of the hand 260 to form the neck 292 at the first end portion 254, or alternatively extend toward the second end portion 272 to form the neck 292 at the second end portion 272 without departing from the scope of the present disclosure. In an embodiment where the first finger 236 and the second finger 238 extend from the first end portion 254 of the hand 260 such that the neck 292 is formed at the first end portion 254, the first finger 236 extends straight outward from the hand 260 and does not include a shoulder. In an embodiment where the first finger 236 and the second finger 238 extend from the second end portion 272 of the hand 260 such that the neck 292 is formed at the second end portion 272, the second finger 238 extends straight outward from the hand 260 and does not include a shoulder.

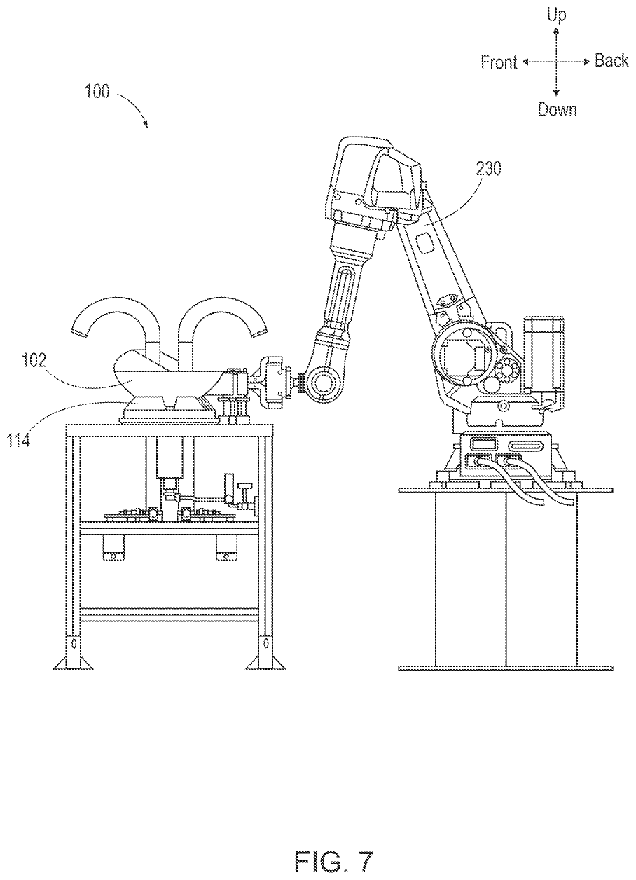

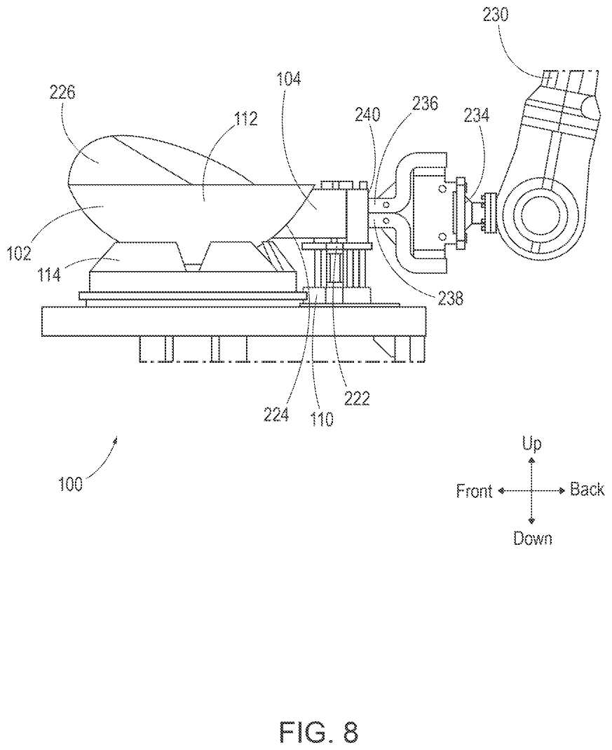

FIG. 7 depicts a side view of the robot arm 230 at the kitchen station 100, engaged with the first pan 102, and FIG. 8 depicts an enlarged, partial side view of the robot arm 230 at the kitchen station 100, including the end effector 234 and the first pan 102. As shown in FIGS. 7 and 8, the first finger 236 and the second finger 238 are inserted in the first aperture 240 at the first handle 104, along the longitudinal direction of the first handle 104 from the proximal end portion 222 of the first handle 104 toward the distal end portion 224 of the first handle 104. The first handle 104 is disposed in the first mount 110 and the first body 112 is seated on the first stove 114. In this configuration, the robot arm 230 is capable of actively managing a cooking operation of food items (not shown) in the first body 112 of the first pan 102 at the first stove 114, including maneuvering the first pan 102 and using the hood 226 to redistribute the food items about the first pan 102.

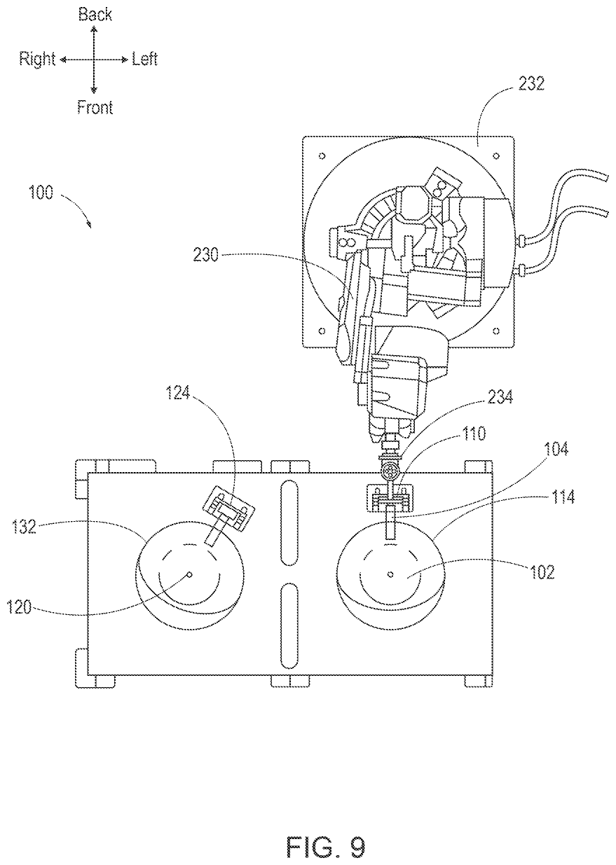

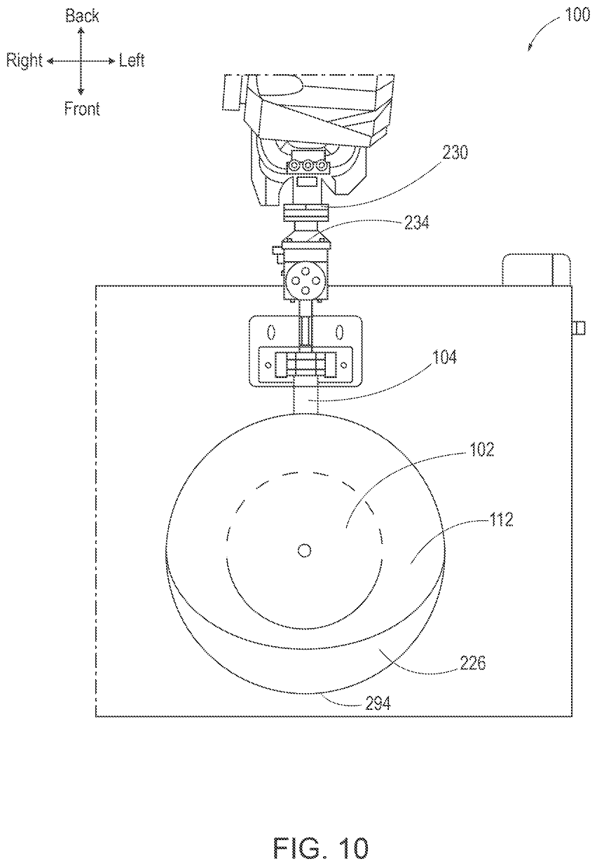

FIG. 9 depicts a top view of the robot arm 230 at the kitchen station 100, engaged with the first pan 102, and FIG. 10 depicts an enlarged, partial top view of the robot arm 230 at the kitchen station 100, including the end effector 234 and the first pan 102. As depicted in FIG. 9, the robot arm 230 is positioned directly in front of the first stove 114 with respect to the front-back direction of the kitchen station 100, and at an angle from the second stove 132 with respect to the front-back direction of the kitchen station 100 and the left-right direction of the kitchen station 100. The first mount 110 is positioned at the first stove 114 between the first stove 114 and the robot arm 230 in the front-back direction of the kitchen station 100, and angled in the front-back direction of the kitchen station 100 toward the robot arm 230 to facilitate the robot arm 230 maneuvering one of the first pan 102 and the second pan 120 on the first mount 110 and over the first stove 114. The second mount 124 is positioned at the second stove 132 between the second stove 132 and the robot arm 230 in the front-back direction of the kitchen station 100 and the left-right direction of the kitchen station 100, and angled in the front-back direction of the kitchen station 100 and the left-right direction of the kitchen station 100 toward the robot arm 230 to facilitate the robot arm 230 maneuvering one of the first pan 102 and the second pan 120 on the second mount 124 and over the second stove 132.

While the depicted kitchen station 100 includes the first stove 114 and the second stove 132, any number of stoves similar to the first stove 114 and the second stove 132, and any number of corresponding pans similar to the first pan 102 and the second pan 120 can be incorporated into the kitchen station 100 without departing from the scope of the present disclosure, where the robot arm 230 is otherwise configured to access each pan at each stove of the kitchen station 100 with the end effector 234. In an embodiment, the base 232 is mobilized and configured to transport the robot arm 230 to multiple stoves across the kitchen station 100.

As depicted in FIG. 10, the first body 112 has a circular profile taken from a top view when the first pan 102 is in the upright position, and the hood 226 extends backward in the front-back direction of the kitchen station 100 over the first body 112 from a front end 294 of the first pan 102 to form the concave portion of the first pan 102, which the robot arm 230 may leverage for flipping or rolling food items (not shown) against the hood 226 to redistribute the food items about the first pan 102. Notably, the first body 112 of the first pan 102 may be alternatively formed as a pot, a wok, a sauce pan, a sheet pan, a cooking sheet, a baking rack, or a similar cooking hardware otherwise configured for being maneuvered by the robot arm 230 through the first handle 104 in a manner similar to the first pan 102 without departing from the scope of the present disclosure. The first handle 104 of the first pan 102 may be additionally or alternatively adapted to a lid, a fork, a spoon, a knife, a spatula, a whisk, a strainer, a grater, or other utensil for use at the kitchen station 100 without departing from the scope of the present disclosure. In an embodiment, the robot arm 230 includes multiple end effectors similar to the end effector 234 for maneuvering multiple items through multiple handles similar to the first handle 104 at a single time. In a further embodiment, the robot arm 230 includes multiple arms and features multiple end effectors similar to the end effector 234. Accordingly, the robot arm 230 is able to accommodate a variety of utensils having end effectors similar to the end effector 234. Therefore, the kitchen station 100 can perform any number of automated cooking tasks with cooking hardware and utensils that are compatible with robot arms for automated cooking systems.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the present disclosure.

1. A cooking hardware configured for selectively engaging an associated end effector of an associated robot arm, the cooking hardware comprising:
a handle having a proximal end portion and a distal end portion;
a body fixed with the distal end portion of the handle, the body being configured for containing food items;
an aperture defined in the handle and extended in a longitudinal direction of the handle from the proximal end portion of the handle toward the distal end portion of the handle, wherein the aperture is configured to receive the associated end effector such that the associated robot arm is capable of maneuvering the cooking hardware about an associated kitchen station through the handle with the associated end effector; and
a first handle protrusion extended outward from the handle in a width direction of the handle perpendicular to the longitudinal direction.

2. The cooking hardware of claim 1, wherein the first handle protrusion forms a rib disposed on the handle along a height direction of the handle perpendicular to the width direction and the longitudinal direction of the handle.

3. The cooking hardware of claim 1, wherein the first handle protrusion occupies a same position as the aperture in the longitudinal direction of the handle and a height direction of the handle perpendicular to the width direction and the longitudinal direction of the handle.

4. The cooking hardware of claim 1, wherein the first handle protrusion extends outward from opposite lateral sides of the handle in the width direction of the handle.

5. The cooking hardware of claim 1, further comprising a second handle protrusion extended outward from the handle in the width direction of the handle, and spaced from the first handle protrusion to define a handle gap with the first handle protrusion in the longitudinal direction of the handle.

6. The cooking hardware of claim 5, wherein the first handle protrusion and the second handle protrusion each form a rib disposed on the handle along a height direction of the handle perpendicular to the width direction and the longitudinal direction of the handle.

7. The cooking hardware of claim 5, wherein the first handle protrusion and the second handle protrusion are disposed along a lateral side of the handle from a bottom portion of the handle toward a top portion of the handle in a height direction of the handle perpendicular to the width direction and the longitudinal direction of the handle.

8. The cooking hardware of claim 5, wherein the first handle protrusion and the second handle protrusion each extend outward from opposite lateral sides of the handle in the width direction of the handle, defining the handle gap between the first handle protrusion and the second handle protrusion at the opposite lateral sides of the handle.

9. The cooking hardware of claim 1, wherein the aperture is defined by inner wall surfaces of the handle that extend straight in a height direction of the handle perpendicular to the width direction and the longitudinal direction of the handle.

10. The cooking hardware of claim 1, wherein the aperture is defined by inner wall surfaces of the handle that extend straight in the width direction of the handle.

11. A cooking hardware support system, comprising:
a cooking hardware configured for selectively engaging an associated end effector of an associated robot arm, the cooking hardware including:
a handle having a proximal end portion and a distal end portion,
a body fixed with the distal end portion of the handle, the body being configured for containing associated food items,
an aperture defined in the handle and extended in a longitudinal direction of the handle from the proximal end portion of the handle toward the distal end portion of the handle, wherein the aperture is configured to receive the associated end effector, and
a first handle protrusion extended outward from the handle in a width direction of the handle perpendicular to the longitudinal direction; and
a mount configured for supporting the handle on an associated kitchen station, the mount including:
a stand configured for being mounted on the associated kitchen station,
a first arm extended from the stand in a height direction of the handle perpendicular to the longitudinal direction and the width direction of the handle, and
a first arm protrusion extended from the first arm in the width direction of the handle, and disposed along the first arm in the height direction of the handle,
wherein when the handle is lowered onto the mount, the handle and the first handle protrusion slide against the first arm and the first arm protrusion in the height direction of the handle from a free position toward a supported position where the stand, wherein the first arm, and the first arm protrusion support the handle in a height direction of the associated kitchen station, obstruct movement of the handle in the longitudinal direction and the width direction of the handle, and maintain the handle in an upright orientation such that the height direction of the handle is aligned with the height direction of the associated kitchen station.

12. The cooking hardware support system of claim 11, wherein the cooking hardware further includes a second handle protrusion extended outward from the handle in the width direction of the handle, and spaced from the first handle protrusion to define a handle gap with the first handle protrusion in the longitudinal direction of the handle, and
wherein when the handle is in the supported position, the first arm protrusion interlocks with the first handle protrusion and the second handle protrusion in the longitudinal direction of the handle.

13. The cooking hardware support system of claim 11, wherein the first arm protrusion is disposed along a side of the handle from a bottom portion toward a top portion of the handle such that the bottom portion of the handle and the first arm protrusion are received against the stand, and the first arm protrusion is received against the first handle protrusion when the handle is in the supported position.

14. The cooking hardware support system of claim 11, further comprising:
a second arm extended from the stand in the height direction of the handle, and spaced from the first arm to define an arm gap with the first arm in the width direction of the handle, the arm gap having a width corresponding to a width of the handle at the first handle protrusion for receiving the handle in the supported position between the first arm and the second arm so as to obstruct movement of the handle in the width direction of the handle and maintain the handle in the upright orientation against the first arm.

15. The cooking hardware support system of claim 14, wherein the first arm, the first arm protrusion, and the second arm extend straight upward from the stand in the height direction of the handle such that movement of the handle between the free position and the supported position is restricted to linear movement in the height direction of the handle.

16. The cooking hardware support system of claim 14, wherein the first handle protrusion extends outward from opposite lateral sides of the handle in the width direction of the handle, and
wherein the mount includes a second arm protrusion extended from the second arm, toward the first arm in the width direction of the handle, and disposed along the second arm in the height direction of the handle such that the handle and the first handle protrusion are configured to slide against the second arm and the second arm protrusion in the height direction of the handle between the free position and the supported position, and engage the mount in the supported position so as to obstruct movement of the handle in the longitudinal direction and the width direction of the handle and maintain the handle in the upright orientation.

17. The cooking hardware support system of claim 16, wherein the handle includes a second handle protrusion extended outward from the opposite lateral sides of the handle in the width direction of the handle, and spaced from the first handle protrusion to define a handle gap with the first handle protrusion in the longitudinal direction of the handle,
wherein when the handle is in the supported position, the first arm protrusion and the second arm protrusion are each interlocked between the first handle protrusion and the second handle protrusion in the longitudinal direction of the handle.

18. The cooking hardware support system of claim 14, wherein the first handle protrusion forms a rib disposed along a perimeter of the handle to extend downward from a bottom portion of the handle in the height direction of the handle to directly engage the stand in the supported position, and extend outward in the width direction of the handle on opposite lateral sides of the handle to directly engage the first arm and the second arm in the supported position.

19. The cooking hardware support system of claim 18, wherein the first handle protrusion is disposed continuously from the bottom portion to at least one lateral side of the handle to form at least one corner, wherein the corner defines an inclined surface extended in the width direction and the height direction of the handle.

20. The cooking hardware support system of claim 14, wherein a first lateral side of the handle defines a planar first lateral side surface, and the first arm defines a planar first arm surface configured to directly engage the first lateral side surface in the supported position,
wherein a second lateral side of the handle opposite the first lateral side in the width direction of the handle defines a planar second lateral side surface, and the second arm defines a planar second arm surface configured to directly engage the second lateral side surface in the supported position, and
wherein a bottom portion of the handle defines a planar bottom side surface, and the stand defines a planar stand support surface configured to directly engage the bottom side surface in the supported position.
